(19) United States
(12) Patent Application Publication
(10) Pub. No.: US 2016/0085224 A1
(43) Pub. Date: Mar. 24, 2016

(54) DEVICE FOR MANAGING AND CONFIGURING FIELD DEVICES IN AN AUTOMATION INSTALLATION

(71) Applicant: ABB TECHNOLOGY AG, Zuerich (CH)

(72) Inventors: Dirk Wagener, Stadthagen (DE); Christoph Welte, Neu-Ulm (DE); Marcus Heege, Kaisersesch (DE); Wolfgang Mahnke, Hettenleidelheim (DE); Marko Schlueter, Espelkamp (DE)

(21) Appl. No.: 14/856,597

(22) Filed: Sep. 17, 2015

(30) Foreign Application Priority Data
Sep. 19, 2014 (DE) 10 2014 014 183.7

(51) Int. Cl. G05B 19/05

(52) U.S. Cl. CPC G05B 19/05; G05B 2219/1138

(57) ABSTRACT

A device for managing and configuring field devices in an automation installation with a configuration tool that is designed to physically detect a field device in the automation installation, to logically incorporate it into the automation installation and to configure it in the automation installation, the configuration tool resorting for this purpose to a prescribed first field-device-specific information packet that describes the functions and data of the field device at least in part. To improve lucidity, a self-contained screen element for calling a plurality of functions of a related functional area is provided, which screen element has a plurality of sensitive subregions, each of the sensitive subregions being denoted by an individual symbol and being designed to call a function of the related functional area.

### CROSS-REFERENCE TO RELATED APPLICATIONS

Priority is claimed to German Patent Application No. DE 10 2014 014 183.7, filed on Sep. 19, 2014, the entire disclosure of which is hereby incorporated by reference herein.

### FIELD

The invention relates to a device for managing and configuring field devices in an automation installation.

### BACKGROUND

Automation systems for controlling a technical process or a technical installation usually comprise a control device (PLC) which is integrated in a group of a multiplicity of intelligent electrical devices. Intelligent electronic devices are microprocessor-based devices, for example protective and control devices, motor protective devices, intelligent switches and voltage regulators, frequency converters, pressure and temperature measuring transducers, flowmeters and actuators.

The article “FDI Device Integration—Best of Both Worlds”, atp edition 6/2010, pages 16 to 19, discloses the practice of integrating field devices into an automation installation using the FDI concept (Field Device Integration IEC-62769). The basis of this concept is the provision of information for configuring field devices in a device-specific FDI packet. This FDI packet comprises a firmly predefined amount of information which consists of a device definition, business logic, a user interface description and user interface plug-ins. The device definition comprises management information and the device model. The business logic describes the communication logic for the device and is used to ensure consistency of the device model. The user interface description describes the presentation of the device parameters and device functions. The user interface plug-ins are programmed components of interface portions for displaying the device parameters and functions.

When configuring field devices by means of EDD (electronic device description) technology IEC 61804, a device manufacturer provides an EDD which comprises information relating to the communication with the device, the business logic and the user interfaces, that is to say which input masks should be displayed for a user. The business logic includes, for example, when which parameters can be written.

FDI technology uses these EDD mechanisms and provides the concept of the FDI package which, in addition to an EDD, may also include other information such as a user handbook or else so-called UIPs (user interface plug-in) which provide further user interfaces in other technologies, for example .NET assemblies, which, in contrast to EDD-based user interfaces, consist of programmed code compiled for a component.

FDI packets are typically created by device manufacturers and are used by system manufacturers to integrate and configure the devices from the device manufacturers in their system.

In addition to an individual user element having different parameters, graphs and other elements, new windows and dialogs may also be defined in the EDD. In this case, a host has certain freedoms and can display a plurality of menus defined in the EDD in different windows at the same time, for example, or else user interfaces of different device entities.

Known EDD host systems either restrict the number of windows or open an arbitrary number of windows for the different devices. This causes the user to lose track of the assignment of the windows to the devices.

In addition, the EDD specification allows an input context to be defined, which input context comprises changes to a device configuration which have already been made by the user at the interface but have not yet been written to the device or the offline configuration. According to the specification, it is possible in this case for different windows and dialogs to work on different input contexts of the same device. This concept makes it even more difficult for a user to assign the windows not only to the device but also to a particular input context.

According to the prior art, EDD host systems display the windows described in the EDD as windows of the application, with the result that the user can compare a plurality of window contents with one another. However, the windows can be assigned to a particular device entity only with difficulty and can be assigned to a particular input context of this device entity with even more difficulty. If a user wishes to use or reject an input context, it is therefore difficult to discern which windows are affected thereby.

In such a programming tool, information relating to the devices is visualized and functions, such as parameter setting, are executed. For this purpose, the user first needs to select a device from a multiplicity of devices.

In order to configure field devices, a configuration tool sends configuration parameters to the relevant field device via a communication network. To this end, the user performs configuration changes in the configuration tool, which then need to be written to the field device by means of a confirmation command, for example by pushing an “OK” or “Apply” button. When there are a multiplicity of known configuration tools, the confirmation command is followed by a further dialog being opened that indicates the changes to the user and asks again whether the changes are really meant to be written to the field device.

These change dialogs are unpopular with most users, since the user constantly receives the dialog and has to confirm it, even if the changes made are marginal and a dialog is not required for them. For this reason, programs today often dispense with this kind of change dialog that appears after the first confirmation. In this case, the user can only carry out this check from the menu of the software, which is very confusing, however, since the changes made can be distributed over many menus. Also, the correlation between the write action for the field device and the changes in question is not always evident.

### SUMMARY

An aspect of the invention provides a device for managing and configuring a field device in an automation installation, the device comprising: a configuration tool, designed to physically detect the field device in the automation installation, to logically incorporate the field device into the automation installation, and to configure the field device in the automation installation; and a self-contained screen element configured to call a plurality of functions of a related functional area, wherein the configuration tool resorts for this purpose to a prescribed first field-device-specific information packet that describes functions and data of the field device at least in part, wherein the self-contained screen element includes a plurality of sensitive subregions, wherein each of the sensitive subregions is denoted by an individual symbol, and wherein each of the sensitive subregions is designed to call a function of the related functional area.

### BRIEF DESCRIPTION OF THE DRAWINGS

The present invention will be described in even greater detail below based on the exemplary FIGURE. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawing which illustrates the following:

FIG. 1 shows a basic illustration of a screen element 1 in the configuration tool.

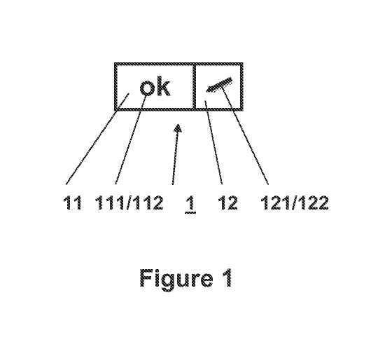

### DETAILED DESCRIPTION

An aspect of the invention relates to a device for managing and configuring field devices in an automation installation, which may be used, in particular, in process automation or machine control for controlling processes and/or installation components.

An aspect of the invention provides a device for managing and configuring field devices in an automation installation in which related functions are provided in an inseparable context with the changes in question for the purpose of lucid operation.

An aspect of the invention provides a device for managing and configuring field devices in an automation installation with a configuration tool that is designed to physically detect a field device in the automation installation, to logically incorporate it into the automation installation and to configure it in the automation installation, the configuration tool resorting for this purpose to a prescribed first field-device-specific information packet that describes the functions and data of the field device at least in part.

An aspect of the invention provides a self-contained screen element for calling a plurality of functions of a related functional area, which screen element has a plurality of sensitive subregions, each of the sensitive subregions being denoted by an individual symbol and being designed to call a function of the related functional area.

Advantageously, this inseparably combines all the related functions in an editing context for operation of the configuration tool in a self-contained screen element.

The invention is explained in more detail below using an exemplary embodiment. The single FIGURE is a basic illustration of a screen element 1 in the configuration tool. The screen element 1 is associated with a change dialog.

In an extremely simple embodiment, the screen element 1 comprises at least two sensitive subregions 11 and 12. The first sensitive subregion 11 is denoted by a first individual symbol 111 and designed to call a first function 112 of a related functional area. The second sensitive subregion 12 is denoted by a second individual symbol 121 and designed to call a second function 122 of the same functional area.

In an extremely simple embodiment, the first individual symbol 111 is a character string “ok” and the associated first function 112 of the related functional area is the confirmation command for writing changes in the configuration parameters to the relevant field device, which first function is triggered by actuation of the first sensitive subregion 11.

The second individual symbol 121 is embodied as a graphical representation of a pen. The associated second function 122 of the same functional area opens a change list for the changed configuration parameters of the relevant field device when the second sensitive subregion 12 is actuated.

The directly adjacent arrangement of both functions 112 and 122 of the same functional area identifies the direct correlation. The user is therefore provided with the opportunity to use just one screen element 1 to write the changed data to the field device or to call the change list.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE SYMBOLS

1 screen element

11, 12 sensitive subregion

111, 121 symbol

112, 122 function

1. A device for managing and configuring a field device in an automation installation, the device comprising:
a configuration tool, designed to physically detect the field device in the automation installation, to logically incorporate the field device into the automation installation, and to configure the field device in the automation installation; and
a self-contained screen element configured to call a plurality of functions of a related functional area,
wherein the configuration tool resorts for this purpose to a prescribed first field-device-specific information packet that describes functions and data of the field device at least in part,
wherein the self-contained screen element includes a plurality of sensitive subregions,
wherein each of the sensitive subregions is denoted by an individual symbol, and
wherein each of the sensitive subregions is designed to call a function of the related functional area.
